(19) United States
(12) Patent Application Publication
(10) Pub. No.: US 2007/0101287 A1
(43) Pub. Date: May 3, 2007

(54) Pop-up windows in a computer system

(75) Inventor: William Gabriel Pagan, Durham, NC (US)

Correspondence Address: IBM CORPORATION, PO BOX 12195, DEPT YXSA, BLDG 002, RESEARCH TRIANGLE PARK, NC, 27709, US

(73) Assignee: INTERNATIONAL BUSINESS MACHINES CORPORATION, ARMONK, NY (US)

(21) Appl. No.: 11/266,512

(22) Filed: Nov. 3, 2005

(51) Int. Cl. G06F 9/00

(52) U.S. Cl. 715/781

(57) ABSTRACT

The present invention provides a method, data processing system and computer program product in which a progressively changing warning is provided to the user of a computer system, over a period of time, to indicate that a pop-up window is to be displayed and given focus. The warning may be a visual and/or an audible effect. In an example visual effect the pop-up window is initially displayed transparently and progressively faded into view by reducing the level of transparency. In an example audible signal is initially output at a low volume and the column is progressively increased. Further the time period of the warning may be varied according to user activity.

### BACKGROUND OF THE INVENTION

1. Field of the Invention

The present invention relates to handling of pop-up windows in a computer system and more particularly to reducing the intrusiveness of such pop-up windows.

2. Background to the Invention

In modern computer systems so called pop-up windows are prevalent in which one window, the pop-up window, immediately appears on a computer screen in front of whatever is currently being viewed/worked upon on the screen, such as other windows. Further such pop-up windows often gain focus which means that any input by the user directly subsequent to appearance of the pop-up window is directed to an input field of the pop-up window until such time as the focus is changed by a user action. As such a window is said to be in focus when it is allocated, for example, to receive input from the keyboard.

Some work has been done to reduce the intrusiveness of pop-up windows by giving them some degree of transparency such that they do not completely block the area of the computer screen which they cover, whilst at the same time giving them sufficient opacity to make then usable by the user.

For example, US20040179017 to NVIDIA Corp. discloses a system in which a user requested pop-up window, such as a drop down menu, is first displayed as transparent in response to a first message and subsequently as opaque in response to a second message.

For example, U.S. Pat. No. 6,118,427 to Silicon Graphics Inc. discloses a system in which the display of an object, for example a window, is varied to provide a level of transparency which optimizes user performance.

For example, U.S. Pat. No. 6,317,128 to Silicon Graphics Inc. discloses a system in which the display of an object, for example a window, is transparent and includes an anti-interference outline to enhance visual distinctiveness.

This prior art assumes that a user has either requested or caused the pop-up window to appear and requires it to perform some function. However pop-up windows can also be unsolicited and unrelated to a current task which the user of a computer system is performing, for example pop-up windows for such things as an instant messaging window, a status message, a calendar event, or an internet advertisement. In this situation when the pop-up window is given focus any subsequent input from the user is directed to the pop-up window in preference to, for example, a window which was in focus and into which the user was inputting immediately before the pop up window appeared. As a result, if the user does not notice the pop-up window when it appears, some user input intended for the window which was in focus immediately before the pop-up window appeared may either be lost or erroneously input into the pop-up window. For example, if a user is typing an e-mail and does not notice that a pop-up instant messaging has appeared and given focus, some input intended for the e-mail window will be incorrectly directed to the instant messaging window until such time as the user notices the pop-up instant messaging window and acts accordingly.

### SUMMARY OF THE INVENTION

The present invention solves this problem by providing a warning to gradually make a user aware that a pop-up window is being displayed such that the user can continue working in a current window for a period of time whilst becoming aware that the pop-up window is to be given focus in preference to the current window.

Accordingly according to a first aspect the present invention provides a method for a data processing system, the method comprising: receiving a request to display, and give focus to, a pop-up window on a computer display; and performing the request comprising: (a) causing a progressively changing warning to be provided to the user over a period of time; and (b) causing the pop-up window to be displayed and given focus after the period of time.

According to a second aspect the present invention provides a data processing system comprising: at least one processor; and memory accessible to the at least one processor and comprising a file system; the at least one processor for performing sub-processes of: receiving a request to display, and give focus to, a pop-up window on a computer display; and performing the request comprising: (a) causing a progressively changing warning to be provided to the user over a period of time; and (b) causing the pop-up window to be displayed and given focus after the period of time.

According to a third aspect the present invention provides a computer program product comprising a computer useable medium having a computer readable program, wherein the computer readable program when executed on a computer causes the computer perform the steps of: receiving a request to display, and give focus to, a pop-up window on a computer display; and performing the request comprising: (a) causing a progressively changing warning to be provided to the user over a period of time; and (b) causing the pop-up window to be displayed and given focus after the period of time.

The warning may comprise either a visual effect or an audible affect or a combination of the two. The pop-up window is not given focus whilst the warning is in progress.

Preferably the visual effect comprises the pop-up window being displayed initially at a given level of transparency and subsequently at a progressively reduced level of transparency. This provides a fade in effect for the pop-up window which enables the window behind the pop-up window to be seen for a period of the warning.

Alternatively the visual effect comprises the pop-up window being displayed initially at a given size and subsequently at a progressively increased size. This provides a growing effect such that the window behind the pop-up window is only gradually obscured.

Alternatively the visual effect comprises the pop-up window being flashed wherein initially the window is displayed for a short period of time and subsequently for a progressively increased period of time. This provides an effect where the pop-up window initially blocks the window behind for only a short period of time but the time is gradually increased.

Alternatively if the warning is an audible signal it comprises an audible signal being output which is initially at a given volume and subsequently at a progressively increased volume. Thus the signal becomes gradually louder.

Alternatively if the warning is an audible signal it comprises an audible signal being output which is initially at a given pitch and subsequently at a progressively increased pitch. Thus the signal becomes gradually higher pitched.

Alternatively the audible signal comprises an audible sound output initially for a short period and subsequently for progressively longer periods. For example if the sound is a beep these are initially separated by relatively large periods without a beep but gradually the beeps become closer together.

Note that any two or more of the different visual and audible effects can be combined to provide a single warning.

The period of time over which the warning is provided should be sufficient to provide a suitable warning to a user. Optionally the period of time is based on providing the warning for a set time period. Alternatively the period of time can be that required to provide a specific visual and/or audible effect. For example if the window is faded-in the period of time can be that which is required to progressively change the level of transparency of the pop-up window between two pre-determined levels of transparency.

Optionally the period of time over which the warning is provided is varied to provide shorter or longer warnings. Optionally a user interface is provided in which the user can specify a type of warning to be used and/or a length of time for the warning to be provided. Alternatively or additionally the period of time can be set according to determined user activity at the time of the warning. For example, if the user is currently using the keyboard the period of time is set to a longer time than compared to that which is set when the keyboard is idle.

Note that the final display of the pop-up window and the giving of focus to the window is not part of the warning. Accordingly, for example, if the warning comprises a fade in of the pop-up window the level of transparency (or opacity) at the end of the warning does not have to be the same as that when the pop-up window is finally displayed.

Further note that whilst the warning is progressively changed there is no requirement for the progression to be uniform. Accordingly, for example, if the warning comprises a fade in of the pop-up window, the rate of fade in may be varied during the warning.

### BRIEF DESCRIPTION OF THE DRAWINGS

Some of the purposes of the invention having been stated, others will appear as the description proceeds when taken in connection with the accompanying drawings, in which:

FIG. 1 is a block diagram of an example data processing environment in which the preferred embodiment of the present invention could be advantageously applied;

FIG. 2 is an illustration of a pop-up window being displayed according to the prior art.

FIG. 3 is an illustration of a pop-up window being displayed according to the preferred embodiment of the present invention; and

FIG. 4 is a flow diagram of causing a pop-up window to be displayed according to the preferred embodiment of the present invention.

### DETAILED DESCRIPTION OF THE ILLUSTRATED EMBODIMENTS

In the following description of the exemplary embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

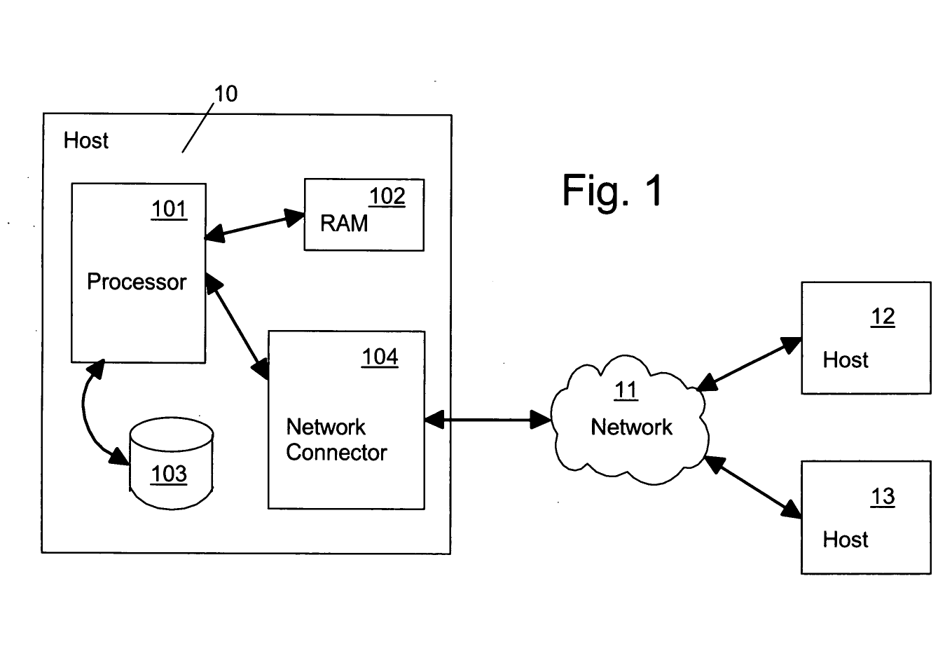

FIG. 1 is a block diagram of an example data processing environment in which the preferred embodiment of the present invention could be advantageously applied. In FIG. 1, a client/server data processing host 10 is connected to other client/server data processing host 12 and 13 via a network 11, which could be, for example, the Internet. Client/server 10 has a processor 101 for executing programs that control the operation of the client/server 10, a RAM volatile memory element 102, a non-volatile memory 103, and a network connector 104 for use in interfacing with the network 11 for communication with the other client/servers 12 and 13. For example client/server 10 may have program instruction code in non-volatile memory 103 to carry out a method according to the preferred embodiment of the present invention.

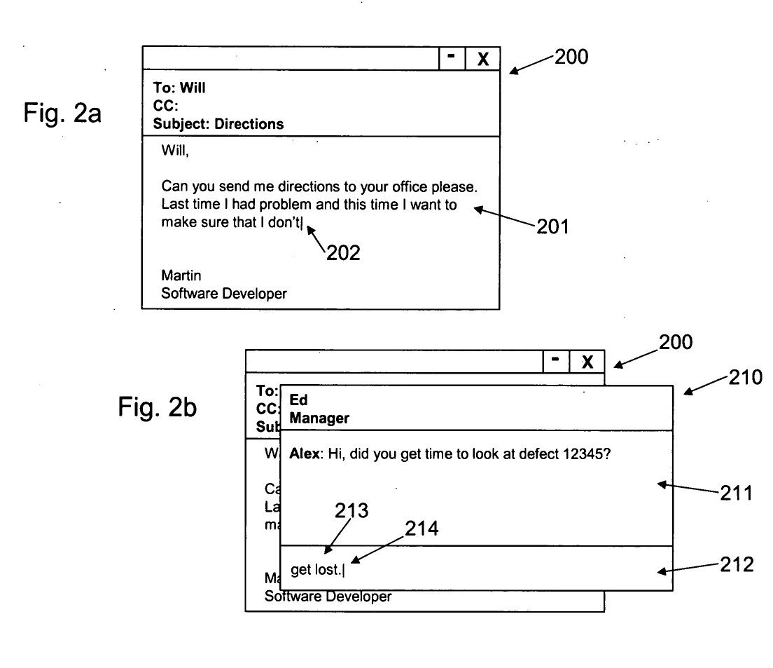

FIGS. 2a and 2b illustrate the problem in the prior art which the present invention is intended to address. FIG. 2a shows an email window 200 into which a user is typing a message 201. The user has reached a position in the message shown by the current cursor position 202 and subsequent text typed by the user into the e-mail message will start from this position. However, if an instant messaging window appears and gains focus at this time any subsequent input by the user will become part of the reply to the instant message rather than a continuation of the e-mail message. As a result if the user does not immediately notice the appearance of the instant pop-up window subsequent text typed by the user and intended for the e-mail message will become part of the response of the instant message window. This situation is shown in FIG. 2b in which instant messaging window 210, which has a message area 211 and response input area 212, has appeared and subsequent text 213 intended for the e-mail message is actually entered into response area 212 of the instant messaging window. At best this is inconvenient to the user by requiring the subsequent text to be deleted from the message response area and re-entered into the e-mail message but may result in the subsequent text being sent as a message response which for example, depending on the text, is potentially confusing or offensive to the original sender of the message.

Note, for the purposes of describing the preferred embodiment of the present invention, a window which is invisible or completely transparent is considered to have a 100% level of transparency and a 0% level of opacity. As a window becomes more visible, or less transparent, or more opaque, it is considered that the level of transparency becomes lower and the level of opacity becomes higher. When the window is fully visible or completely opaque it is considered to have a 0% level of transparency or a 100% level of opacity. Further a 99% level of transparency refers to the maximum level of transparency which the software which implements the preferred embodiment of the present invention is capable of specifying to a display device and a 100% level of opacity refers to the maximum level of opacity which the software is capable of specifying to a display device. Further whilst it is assumed that the display device in use is capable of displaying a window at different levels of transparency, the capabilities of the display device and are not a subject of the present invention.

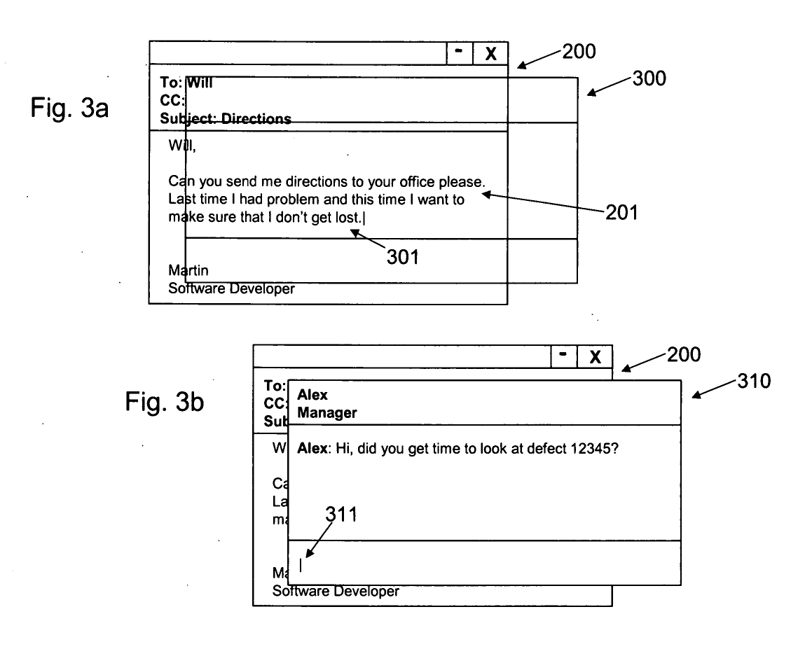

FIGS. 3a and 3b illustrate the preferred embodiment of the present invention. FIG. 3a follows on from FIG. 2a and shows a substantially transparent instant message pop-up window 300 which is not given focus. As a result the e-mail message can still be seen through the instant message window and subsequent text 301 typed by the user is part of the e-mail message rather than part of a response to the instant message. The instant message window is faded in by progressively making it more visible over a pre-determined amount of time after which, as shown in FIG. 3b, a fully opaque instant message window 310 is displayed and given focus as indicated by the presence of the cursor 311. Accordingly the fade-in of the instant message serves as a warning to the user of the presence of the instant messaging window and this both allows the user additional time to become aware of the instant messaging window and help prevent text typed in and intended for the email message being entered into the response field of the instant message window whilst the user is unaware of the instant message window.

Note that in FIG. 3a the border of the instant message window 300 is included for illustration purposes only. In the preferred embodiment of the present invention the border of the pop-up window has the same transparent properties as the remainder of the window. Further, for the purposes of illustration, the window is shown as completely transparent although sufficient time has passed for the user to type all of the subsequent text “get lost”. In the preferred embodiment of the present invention the instant messaging window 300 would have some level of opacity at this time.

Note that in FIGS. 2a, 2b, 3a and 3b a user is entering an e-mail into an e-mail window when a pop-up window appears to display a message from a different user. Note that in the figures these are not intended to be windows of any specific e-mail or instant message software, and further not intended to display all functions of such software.

The preferred embodiment of the present invention is implemented in the operating system's window management scheme, that is the software which manages the window-based user interface, window behavior, window lay-out, window ordering etc. For example in the Windows™ C++ programming interface a pop up application may use the function nsIAppShellService::CreateTopLevelWindow to display its windows, the function nsIDOMWindow::OpenDialog to display dialogs, and the function SetWindowPos to reposition an existing window to the top. These functions make calls to the operating system which is responsible for interpreting the application programmer's request and carrying them out according to specifications.

In the preferred embodiment of the invention the operating system, in carrying out these requests, causes a newly created window to be faded into view. In an alternative embodiment the operating system can require a parameter to be passed in to one of these functions to enable this behavior. In yet another embodiment the programming interface could be extended to provide a new function which enables or disables the fade-in behavior of any particular window. Whichever embodiment the operating system calls the video device drivers which drive a video card which signals a display device, such as a monitor, to present the window and its behavior to a user. A skilled person will understand how this may be performed.

Note that whilst the preferred embodiment has been described in terms of C++ functions in the Windows environment a skilled person will realize that other functions which are equivalent may be used. For example such functions may be provided in different programming languages and different operating systems.

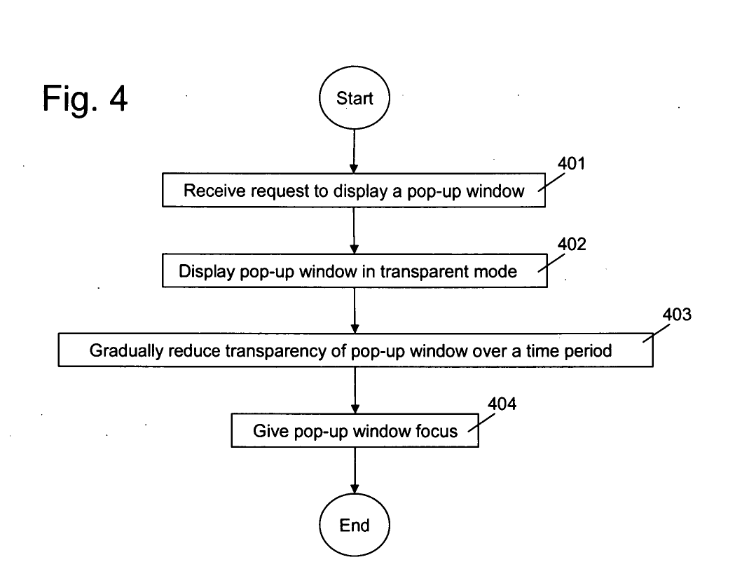

FIG. 4 is a flow diagram of the main steps which are performed by operating system software which implements the preferred embodiment of the present invention. At step 401 a request is received from an application, for example an instant messaging application, to display a pop-up window and give it focus. At step 402 the operating system software requests a display device to display the window initially in a transparent mode with an initial level of transparency or opacity. At step 403 the operating system repeatedly requests, over a pre-determined period of time, the display device to display the window with a level of transparency which progressively decreases (or a level of opacity which progressively increases), thus creating a fade in effect for the display of the window. Finally, at step 404 the operating system causes the pop-up window to be displayed at a pre-determined level of opacity and causes the pop-up window to gain focus. Accordingly the fade in of the pop-up window served as a warning to the user that the pop-up window was to be given focus.

Note that in the preferred embodiment of the present invention the, initial level of transparency at which the pop-up window is displayed, the level of opacity at which a pop-up window is given focus, and the fade in rate (i.e.: the pre-determined time for performing step 403) may varied by the user via a provided user interface. Alternatively, or in addition, the fade in rate may be dynamically changed according to the current activity of the user. For example, if the user is determined to be busy as a result of the keyboard being in use the fade in rate is made slower when compared to the fade in rate if the keyboard is idle.

Note that the fade in of a pop-up window serves as a progressive warning to the user that the pop-up window is to gain focus. In alternative embodiment different techniques to provide such a progressive warning can be used. For example in another embodiment the pop-up window could be displayed initially in a pre-determined relatively smaller size and gradually increased in size until it reaches a pre-determined relatively larger size at which point it is given focus. For example in another embodiment the pop-up window could be alternately displayed and not displayed, initially being displayed for a relatively short time and not displayed for a relatively long time, the time of display being gradually increased and optionally the time of not being displayed gradually decreased, until the time of display reaches a predetermined duration at which time the pop-up window it is displayed permanently and given focus.

In yet another embodiment the warning may comprise an audible signal in addition to, or instead of a visual effect. For example an audible signal can be output which is initially at a given volume and subsequently at a progressively increased volume. Thus the signal becomes gradually louder. Alternatively, for example, an audible signal can be output which is initially at a given pitch and subsequently at a progressively increased pitch. Alternatively, for example an audible signal can be output initial for a given the period and subsequently for progressively increased time periods. For example if the sound is a beep these are initially separated by relatively large periods without a beep but gradually the beeps become closer together. Further the duration of the beeps may be progressively increased.

Note, for an audible signal, system software which implements the invention will drive a speaker or speakers attached to a data processing host using appropriate device drivers. A skilled person will understand how this may be performed.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

In summary the present invention provides a method, data processing system and computer program product in which a progressively changing warning is provided to the user of a computer system, over a period of time, to indicate that a pop-up window is to be displayed and given focus. The warning may be a visual and/or an audible effect. In an example visual effect the pop-up window is initially displayed transparently and progressively faded into view by reducing the level of transparency. In an example audible signal is initially output at a low volume and the column is progressively increased. Further the time period of the warning may be varied according to user activity.

What is claimed is:

1. A method for a data processing system, the method comprising:
a. receiving a request to display, and give focus to, a pop-up window on a computer display; and
b. performing the request comprising:
(a) causing a progressively changing warning to be provided to the user over a period of time; and
(b) causing the pop-up window to be displayed and given focus after the period of time.

2. The method of claim 1 wherein the warning comprises at least one of a visual effect and an audible effect.

3. The method of claim 1 wherein causing a progressively changing warning comprises:
a. causing the pop-up window to be displayed at a given level of transparency; and
b. causing the pop-up window to be displayed at progressively reduced levels of transparency.

4. The method of claim 1 wherein causing a progressively changing warning comprises:
a. causing the pop-up window to be displayed at a given size; and
b. causing the pop-up window to be displayed at progressively increased sizes.

5. The method of claim 1 wherein causing a progressively changing warning comprises:
a. causing the pop-up window to be displayed for a short time;
b. causing the pop-up window to be displayed for progressively longer times.

6. The method of claim 1 wherein the method further comprises:
responsive to determining that a user is currently actively using the data processing system, causing the warning to be provided for a relatively longer period of time; and
responsive to determining that no user is currently actively using the data processing system, causing the warning to be provided for a relatively shorter period of time.

7. The method of claim 1 wherein causing a progressively changing warning comprises:
a. causing an audible signal to be being output at a given volume; and
b. causing the audible signal to be output at a progressively increasing volume.

8. The method of claim 1 wherein causing a progressively changing warning comprises:
a. causing an audible signal to be being output at a given pitch; and
b. causing the audible signal to be output at a progressively increasing pitch.

9. The method of claim 1 wherein causing a progressively changing warning comprises:
a. causing an audible signal to be output as for a short period; and
b. causing the audible signal to be output for progressively increasing periods.

10. A data processing system comprising:
at least one processor; and
memory accessible to the at least one processor and comprising a file system;
the at least one processor for performing sub-processes of:
a. receiving a request to display, and give focus to, a pop-up window on a computer display; and
b. performing the request comprising:
(a) causing a progressively changing warning to be provided to the user over a period of time; and
(b) causing the pop-up window to be displayed and given focus after the period of time.

11. The data processing system of claim 10 wherein the warning comprises at least one of a visual effect and an audible effect.

12. The data processing system of claim 10 wherein causing a progressively changing warning comprises:
a. causing the pop-up window to be displayed at a given level of transparency; and
b. causing the pop-up window to be displayed at progressively reduced levels of transparency.

13. The data processing system of claim 10 wherein causing a progressively changing warning comprises:
a. causing the pop-up window to be displayed at a given size; and
b. causing the pop-up window to be displayed at progressively increased sizes.

14. The data processing system of claim 10 wherein causing a progressively changing warning comprises:
a. causing the pop-up window to be displayed for a short time;
b. causing the pop-up window to be displayed for progressively longer times.

15. The data processing system of claim 10 wherein the sub-process further comprises:
responsive to determining that a user is currently actively using the data processing system, causing the warning to be provided for a relatively longer period of time; and
responsive to determining that no user is currently actively using the data processing system, causing the warning to be provided for a relatively shorter period of time.

16. The data processing system of claim 10 wherein causing a progressively changing warning comprises:
a. causing an audible signal to be being output at a given volume; and
b. causing the audible signal to be output at a progressively increasing volume.

17. The data processing system of claim 10 wherein causing a progressively changing warning comprises:
a. causing an audible signal to be being output at a given pitch; and
b. causing the audible signal to be output at a progressively increasing pitch.

18. The data processing system of claim 10 wherein causing a progressively changing warning comprises:
a. causing an audible signal to be output as for a short period; and
b. causing the audible signal to be output for progressively increasing periods.

19. A computer program product comprising a computer useable medium having a computer readable program, wherein the computer readable program when executed on a computer causes the computer perform the steps of:
a. receiving a request to display, and give focus to, a pop-up window on a computer display; and
b. performing the request comprising:
(a) causing a progressively changing warning to be provided to the user over a period of time; and
(b) causing the pop-up window to be displayed and given focus after the period of time.

20. The computer program product of claim 19 wherein the warning comprises at least one of a visual effect and an audible effect.

21. The computer program product of claim 19 wherein causing a progressively changing warning comprises:
a. causing the pop-up window to be displayed at a given level of transparency; and
b. causing the pop-up window to be displayed at progressively reduced levels of transparency.

22. The computer program product of claim 19 wherein causing a progressively changing warning comprises:
a. causing the pop-up window to be displayed at a given size; and
b. causing the pop-up window to be displayed at progressively increased sizes.

23. The computer program product of claim 19 wherein causing a progressively changing warning comprises:
a. causing the pop-up window to be displayed for a short time;
b. causing the pop-up window to be displayed for progressively longer times.

24. The computer program product of claim 19 wherein the steps further comprise:
responsive to determining that a user is currently actively using the computer, causing the warning to be provided for a relatively longer period of time; and
responsive to determining that no user is currently actively using the computer, causing the warning to be provided for a relatively shorter period of time.

25. The computer program product of claim 19 wherein causing a progressively changing warning comprises:
a. causing an audible signal to be being output which at a given volume; and
b. causing the audible signal to be output at a progressively increasing volume.

26. The computer program product of claim 19 wherein causing a progressively changing warning comprises:
a. causing an audible signal to be being output at a given pitch; and
b. causing the audible signal to be output at a progressively increasing pitch.

27. The computer program product of claim 19 wherein causing a progressively changing warning comprises:
a. causing an audible signal to be output as for a short period; and
b. causing the audible signal to be output for progressively increasing periods.
